(19) United States
(12) Patent Application Publication
(10) Pub. No.: US 2016/0171108 A1
(43) Pub. Date: Jun. 16, 2016

(54) METHOD AND SYSTEM FOR INDEXING AND PROVIDING SUGGESTIONS

(71) Applicant: Yahoo! Inc., Sunnyvale, CA (US)

(72) Inventors: Zhongqiang Chen, San Jose, CA (US); Shenhong Zhu, Santa Clara, CA (US); Chun Ming Sze, Sunnyvale, CA (US); Xiaobing Han, San Jose, CA (US); Hui Wu, Sunnyvale, CA (US); Farzin Maghoul, Hayward, CA (US)

(21) Appl. No.: 14/569,292

(22) Filed: Dec. 12, 2014

(51) Int. Cl. G06F 17/30; H04L 29/08

(52) U.S. Cl. CPC G06F 17/30867; G06F 17/3053; H04L 67/32

(57) ABSTRACT

The present teaching relates to methods, systems, and programming for indexing and providing suggestions. In one example, a method, implemented on at least one machine each of which has at least one processor, storage, and a communication platform connected to a network for providing a suggestion is presented. An input from a user is first received. At least a part of the input is processed to generate a plurality of tokens. At least one multi-layered key is generated based on one or more of the plurality of tokens. One or more suggestions are retrieved based on the at least one multi-layered key. At least one of the one or more suggestions is provided to be presented to the user.

### BACKGROUND

1. Technical Field

The present teaching relates to methods, systems, and programming for Internet services. Particularly, the present teaching is directed to methods, systems, and programming for indexing and providing suggestions.

2. Discussion of Technical Background

Online content search is a process of interactively searching for and retrieving requested information via a search application running on a local user device, such as a computer or a mobile device, from online databases. Online search is conducted through search engines, which are programs running at a remote server and searching documents for specified keywords and return a list of the documents where the keywords were found. Known major search engines have search assistance including features called “search suggestion” or “query suggestion” designed to help a user narrow in on what the user is looking for.

Search-as-you-type is one of the mechanisms employed in search assistance. For example, as a user types a search query, a list of search suggestions that have been used by many other users before are displayed to assist the user in selecting a desired search query before they hit the actual search button or any specific hyperlink. A search suggestion database may be built offline by mining search logs stored in a query log database. Search suggestion candidates in such a database are typically arranged in alphabetic order, and string prefix matching mechanisms are often employed to discover and retrieve search suggestions from the database. However, prefix matching is unlikely to retrieve search suggestions whose token variances or orders are different from the search query entered by the user, which may cause low suggestion coverage. From this deficiency relevance of search suggestions may also suffer.

Moreover, a misspelled word in a search query may render the search query ineffective—the search query may lead to few or no search suggestions or results. Search assistance of a search engine may include spelling correction features. Many spelling correction algorithms involve complicated models such as language models or natural language models, making it difficult to assess their effectiveness and efficiency, or make improvements.

Therefore, there is a need to provide an improved solution for suggestion to solve the above-mentioned problems.

### SUMMARY

The present teaching relates to methods, systems, and programming for Internet services. Particularly, the present teaching is directed to methods, systems, and programming for indexing and providing suggestions.

In one example, a method, implemented on at least one machine each of which has at least one processor, storage, and a communication platform connected to a network for providing a suggestion is presented. An input from a user is first received. At least a part of the input is processed to generate a plurality of tokens. At least one multi-layered key is generated based on one or more of the plurality of tokens. One or more suggestions are retrieved based on the at least one multi-layered key. At least one of the one or more suggestions is provided to be presented to the user.

In another example, a system having at least one processor, storage, and a communication platform for providing a suggestion is presented. The system includes a tokenization module, a key formation module, and a suggestion generator. The tokenization module is configured to process at least a part of an input from a user to generate a plurality of tokens. The key formation module is configured to form at least one multi-layered key based on one or more of the plurality of tokens. The suggestion generator is configured to retrieve, based on the at least one multi-layered key, one or more suggestions.

In a different example, a method, implemented on at least one machine each of which has at least one processor, storage, and a communication platform connected to a network for maintaining a suggestion candidate database is presented. A suggestion candidate is first obtained. At least a part of the suggestion candidate is processed to generate a plurality of tokens. At least one multi-layered key is generated based on one or more of the plurality of tokens. The at least one multi-layered key is associated with the suggestion candidate. The suggestion candidate and the at least one multi-layered key are stored.

In a further example, a system having at least one processor, storage, and a communication platform for maintaining a suggestion candidate database is presented. The system includes a tokenization module, a key formation module, and a key storage unit. The tokenization module is configured to process at least a part of a suggestion candidate to generate a plurality of tokens. The key formation module is configured to form at least one multi-layered key based on one or more of the plurality of tokens. The key storage unit is configured to store the at least one multi-layered key associated with the suggestion candidate.

Other concepts relate to software for implementing the present teaching on indexing and providing suggestions. A software product, in accord with this concept, includes at least one machine-readable non-transitory medium and information carried by the medium. The information carried by the medium may be executable program code data, parameters in association with the executable program code, and/or information related to a user, a request, content, or information related to a social group, etc.

In one example, a non-transitory machine readable medium having information recorded thereon for providing a suggestion is presented. The recorded information, when read by the machine, causes the machine to perform a series of processes. An input from a user is first received. At least a part of the input is processed to generate a plurality of tokens. At least one multi-layered key is generated based on one or more of the plurality of tokens. One or more suggestions are retrieved based on the at least one multi-layered key. At least one of the one or more suggestions is provided to be presented to the user.

In another example, a non-transitory machine readable medium having information recorded thereon for providing a suggestion is presented. The recorded information, when read by the machine, causes the machine to perform a series of processes. A suggestion candidate is first obtained. At least a part of the suggestion candidate is processed to generate a plurality of tokens. At least one multi-layered key is generated based on one or more of the plurality of tokens. The at least one multi-layered key is associated with the suggestion candidate. The suggestion candidate and the at least one multi-layered key are stored.

Additional features will be set forth in part in the description which follows, and in part will become apparent to those skilled in the art upon examination of the following and the accompanying drawings or may be learned by production or operation of the examples. The features of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1 and 2 illustrate exemplary system configurations in which a search suggestion engine may be deployed in accordance with various embodiments of the present teaching;

FIG. 3 depicts an exemplary diagram of a search suggestion engine of the systems shown in FIGS. 1 and 2, according to an embodiment of the present teaching;

FIG. 4 depicts an exemplary diagram of a key generator, according to an embodiment of the present teaching;

FIG. 5 depicts a flowchart of an exemplary process for generating a multi-layered key, according to an embodiment of the present teaching;

FIGS. 6 and 7 depict exemplary multi-layered keys, according to an embodiment of the present teaching;

FIG. 8 depicts an exemplary diagram of a suggestion generator, according to an embodiment of the present teaching;

FIG. 9 depicts a flowchart of an exemplary process for generating suggestions;

FIG. 10 depicts an exemplary diagram of a scoring module, according to an embodiment of the present teaching;

FIG. 11 depicts an example of obtaining a suggestion candidate based on an input from a user, according to an embodiment of the present teaching;

FIG. 12 illustrates an example of obtaining a suggestion candidate based on an input from a user, according to the embodiment depicted in FIG. 11;

FIG. 13 depicts another example of obtaining a suggestion candidate based on an input from a user, according to an embodiment of the present teaching;

FIG. 14 illustrates an example of obtaining a suggestion candidate based on an input from a user, according to the embodiment depicted in FIG. 13;

FIG. 15 depicts a further example of obtaining a word suggestion based on an input word, according to an embodiment of the present teaching;

FIG. 16 depicts the architecture of a mobile device which may be used to implement a specialized system incorporating the present teaching; and

FIG. 17 depicts the architecture of a computer which may be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of efficient and effective search assistance. The method and system, realized as a specialized and networked system by utilizing one or more computing devices (e.g., mobile phone, personal computer, etc.) and network communications (wired or wireless), relate to suggestions in response to an input from a user. The method and system involve creating and using multi-layered keys for indexing and providing suggestions. The multi-layered keys are based on one or more tokens from the suggestions. The method and system may address various considerations including, e.g., retrieval time, suggestion coverage, relevance between a suggestion and the input, popularity of the suggestion, consumption of computational resources in a real-time online search, or the like. The method and system disclosed herein may be integrated into an existing system, or used with other techniques such as, e.g., stemming, stop word handling, indexing tiering, or the like.

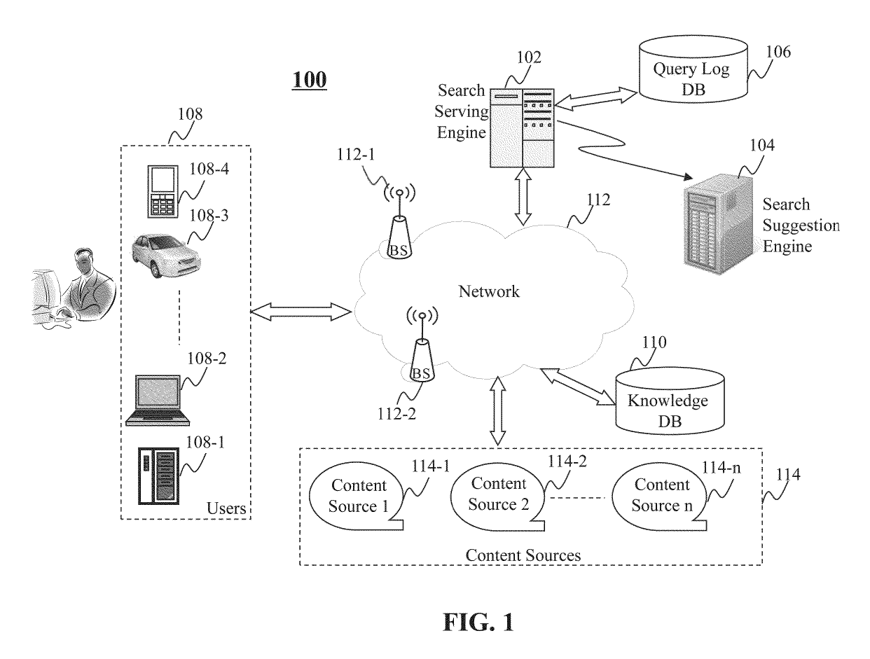

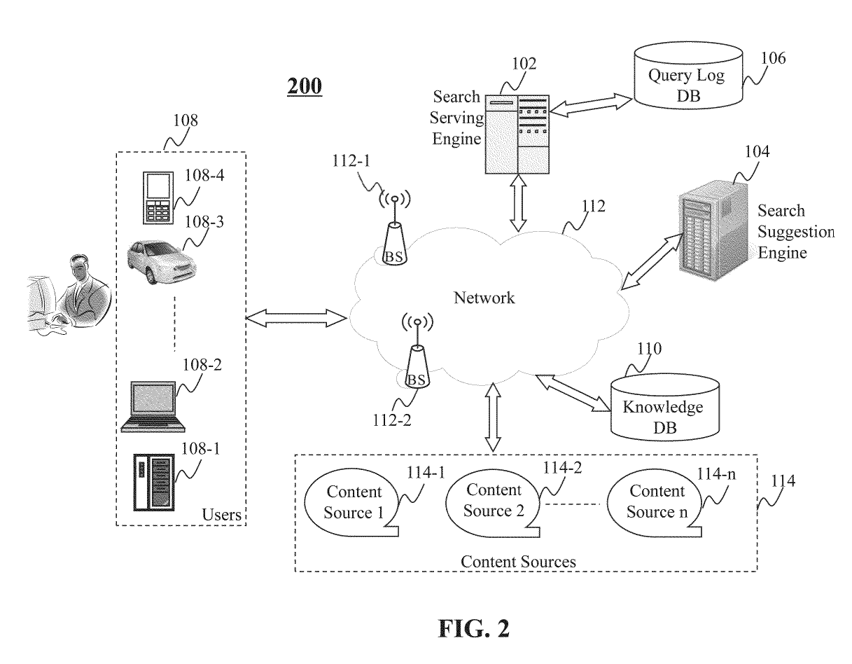

FIGS. 1 and 2 illustrate exemplary system configurations in which a search suggestion engine 104 may be deployed in accordance with various embodiments of the present teaching. In FIG. 1, the exemplary networked environment 100 includes the search suggestion engine 102, the search serving engine 104, a query log database 106, one or more users 108, a knowledge database 110, a network 112, and content sources 114.

The network 112 may be a single network or a combination of different networks. For example, the network 112 may be a local area network (LAN), a wide area network (WAN), a public network, a private network, a proprietary network, a Public Telephone Switched Network (PSTN), the Internet, a wireless network, a virtual network, or any combination thereof. The network 112 may also include various network access points, e.g., wired or wireless access points such as base stations or Internet exchange points 112-1, . . . , 112-2, through which a data source may connect to the network 112 in order to transmit information via the network 112.

Users 108 may be of different types such as users connected to the network 112 via desktop computers 108-1, laptop computers 108-2, a built-in device in a motor vehicle 108-3, or a mobile device 108-4. A user 108 may send an input as a search request to the search serving engine 102 via the network 112 and receive suggestions and search results from the search serving engine 102. In this embodiment, the search suggestion engine 104 serves as a backend sub-system for providing suggestions to the search serving engine 102. The search serving engine 102 and search suggestion engine 104 may access information stored in the query log database 106 and knowledge database 110 directly or via the network 112. The information in the query log database 106 and knowledge database 110 may be generated by one or more different applications (not shown), which may be running on the search serving engine 102, at the backend of the search serving engine 102, or as a completely standalone system capable of connecting to the network 112, accessing information from different sources, analyzing the information, generating structured information, and storing such generated information in the query log database 106 and knowledge database 110.

The content sources 114 include multiple content sources 114-1, 114-2, . . . , 114-n, such as vertical content sources (domains). A content source 114 may correspond to a website hosted by an entity, whether an individual, a business, or an organization such as USPTO.gov, a content provider such as cnn.com and Yahoo.com, a social network website such as Facebook.com, or a content feed source such as tweeter or blogs. The search serving engine 102 may access information from any of the content sources 114-1, 114-2, . . . , 114-n. For example, the search serving engine 102 may fetch content, e.g., websites, through its web crawler to build a search index.

FIG. 2 is a high level depiction of another exemplary networked environment 200 in which the present teaching is applied, according to an embodiment of the present teaching. The networked environment 200 in this embodiment is similar to the networked environment 100 in FIG. 1, except that the search suggestion engine 104 in this embodiment directly connects to the network 112. For example, an independent service provider with the search suggestion engine 104 may serve multiple search engines via the network 112.

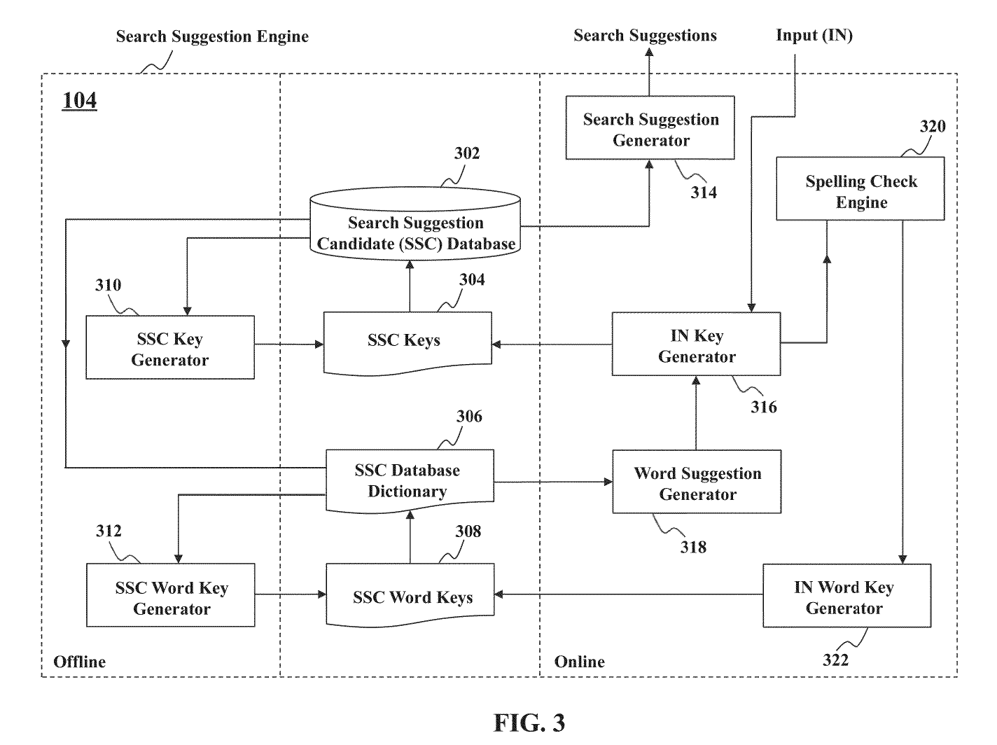

FIG. 3 depicts an exemplary diagram of a search suggestion engine 104 of the systems shown in FIGS. 1 and 2, according to an embodiment of the present teaching. In this embodiment, the search suggestion engine 104 includes a search suggestion candidate (SSC) database 302, SSC keys 304 for indexing search suggestion candidates in the SSC database 302, a SSC database dictionary 306, and SSC word keys 308 for indexing SSC words in the SSC database dictionary 306. In communication with these components, the search suggestion engine 104 further includes an offline portion and an online portion. The offline portion relates to functions of the search suggestion engine 104 that are independent of a specific search request or input from a user. The online portion relates to functions of the search suggestion engine 104 that are in response to or based on a specific search request or input from a user. The search suggestion engine 104 may be centralized or distributed. In other embodiments, one or more of the components including the SSC database 302, the SSC keys 304, the SSC database dictionary 306, and the SSC word keys 308 are not part of but in communication with the offline portion and the online portion of the search suggestion engine 104. Merely by way of example, the search suggestion engine 104 that includes the offline portion and the online portion services a search suggestion database via the network 112.

The offline portion of the search suggestion engine 104 may relate to functions including, e.g., maintaining the SSC database 302, and/or the SSC database dictionary 306. Merely by way of example, the offline portion may be configured such that the SSC database 302 may be updated based on information from a query log database 106 or elsewhere. The information may relate to search activities of general user population, those of a group of users, or those of a specific user. As another example depicted in FIG. 3, the offline portion may be configured to index search suggestion candidates in the SSC database 302, and index SSC words in the SSC database dictionary 306. The SSC database dictionary 306 may include words in the search suggestion candidates of the SSC database 302, herein referred to as SSC words. In some embodiments, stop words, e.g., the, “an,” “a,” “is,” “which,” or the like, are excluded from the SSC database dictionary 306.

In the embodiment depicted in FIG. 3, the offline portion of the search suggestion engine 104 includes a SSC key generator 310 and a SSC word key generator 312. In other embodiments, the offline portion of the search suggestion engine 104 may include one of the SSC key generator 310 and the SSC word key generator 312.

The SSC key generator 310 may be configured to generate one or more SSC keys 304 for a search suggestion candidate. Search suggestion candidates to be processed by the SSC key generator 310 may include those already stored in the SSC database 302, or those to be stored in the SSC database 302. The one or more SSC keys 304 may be used as an index for the search suggestion candidate in the SSC database 302. That is, the search suggestion candidate may be retrieved from the SSC database 302 based on the one or more SSC keys 304 thereof.

SSC keys 304 may be stored in an index structure or a SSC key storage unit (not shown). The key storage unit is in communication with the SSC database 302. As discussed below, a search suggestion candidate may be processed to generate one or more SSC keys 304; conversely, various search suggestion candidates may share a same SSC key 304. The SSC key storage unit stores, in addition to a SSC key 304 itself, information including, e.g., its association with one or more search suggestion candidates, as well as other parameters related to the association. The SSC key storage unit may be accessed by, e.g., the online portion of the search suggestion engine 104.

Similarly, the SSC word key generator 312 may be configured to generate one or more SSC word keys 308 for a SSC word. SSC words to be processed by the SSC word key generator 312 may include those already stored in the SSC database dictionary 306, or those to be stored in the SSC database dictionary 306. The one or more SSC word keys 308 may be used as an index for the SSC word in the SSC database dictionary 306. That is, the SSC word may be retrieved from the SSC database dictionary 306 based on the one or more SSC word keys 308 thereof.

SSC word keys 308 may be stored in an index structure or a SSC word key storage unit (not shown). The SSC word key storage unit is in communication with the SSC database dictionary 306. As discussed below, a SSC word may be processed to generate one or more SSC word keys 308; conversely, various SSC words may share a same SSC word key 308. The SSC word key storage unit stores, in addition to a SSC word key 308 itself, information including, e.g., its association with one or more SSC words. The SSC word key storage unit may be accessed by, e.g., the online portion of the search suggestion engine 104.

The online portion of the search suggestion engine 104 may relate to functions including, e.g., analyzing or processing an input provided in a specific search request from the user, providing suggestions based on the input, or the like. In the embodiment depicted in FIG. 3, the online portion of the search suggestion engine 104 includes an input key generator 314, a spelling check engine 320, an input word key generator 322, a word suggestion generator 318, and a search suggestion generator 314. In other embodiments, the online portion of the search suggestion engine 104 may include some but not all of these components.

The input key generator 316 may process an input from a user to generate one or more input keys in a manner that essentially mirrors the manner in which the SSC key generator 310 generates one or more SSC keys 304 for a search suggestion candidate. The one or more input keys may be used to search for corresponding SSC keys 304 of search suggestion candidates in the SSC database 302, in order to retrieve potential search suggestions from the SSC database 302 by the search suggestion generator 314. As used herein, when a search suggestion candidate is retrieved from the SSC database 302 by the search suggestion generator 314, it is then referred to as a search suggestion. Various criteria may be used to this end. An exemplary criterion is that a search suggestion may be retrieved by the search suggestion generator 314 when one input key corresponds to a SSC key of the search suggestion candidate in the SSC database 302. Another exemplary criterion is that a search suggestion may be retrieved by the search suggestion generator 314 when a number of input keys (e.g., two, three, or more) correspond to the same number of SSC keys of the search suggestion candidate in the SSC database 302.

The search suggestion generator 314 may process the retrieved search suggestions. Merely by way of example, the search suggestion generator 314 scores the retrieved search suggestions, ranks them based on the scores, and selects the top few search suggestions to be presented to the user.

There are situations where few or no search suggestions are retrieved in response to an input from a user. Merely by way of example, if an input from the user includes a misspelled word (e.g., the user enters the input “bettery installation” instead of “battery installation”), one or more input keys may include the misspelled word. The one or more input keys including the misspelled word may correspond to few or no SSC keys 304, causing few or no search suggestions to be retrieved from the SSC database 302. In such a situation, the input may be forwarded to the spelling check engine 320 where the misspelled word is identified. The misspelled word may be then forwarded to the input word key generator 322 for processing.

The input word key generator 322 may process a word of an input to generate one or more input word keys in a manner that essentially mirrors the manner in which the SSC word key generator 312 generates one or more SSC word keys 308 for a SSC word. The one or more input word keys may be used to search for corresponding SSC word keys 308 in order to retrieve potential word suggestions from the SSC database dictionary 306. Various criteria may be used to this end. Similar to the criteria applicable in the context of retrieving search suggestions based on SSC keys and input keys as already discussed, a word suggestion may be retrieved when one or more input word keys correspond to one or more SSC word keys of a SSC word in the SSC database dictionary 308. The word suggestion generator 318 may process the retrieved word suggestions. Merely by way of example, the search suggestion generator 314 scores the retrieved word suggestions, ranks them based on the scores, and selects the top few word suggestions. Then the input may be modified by replacing the misspelled word with one of the selected word suggestions. As another example, the top few word suggestions may be provided to the user, alone or with the original input from the user, such that the user may choose which word suggestion is the desired one. The original input may be modified by replacing the misspelled word with the word suggestion chosen by the user, and the modified input may be forwarded to the input key generator 316 to generate input keys that are used to retrieve search suggestions as already described.

The spelling correction process may be repeated for other words in the input if needed. Subsequently, the modified input may be processed by the input key generator 316 to generate input keys that are used to retrieve search suggestions as already described.

Various components of the search suggestion engine 104 are described in further detail below.

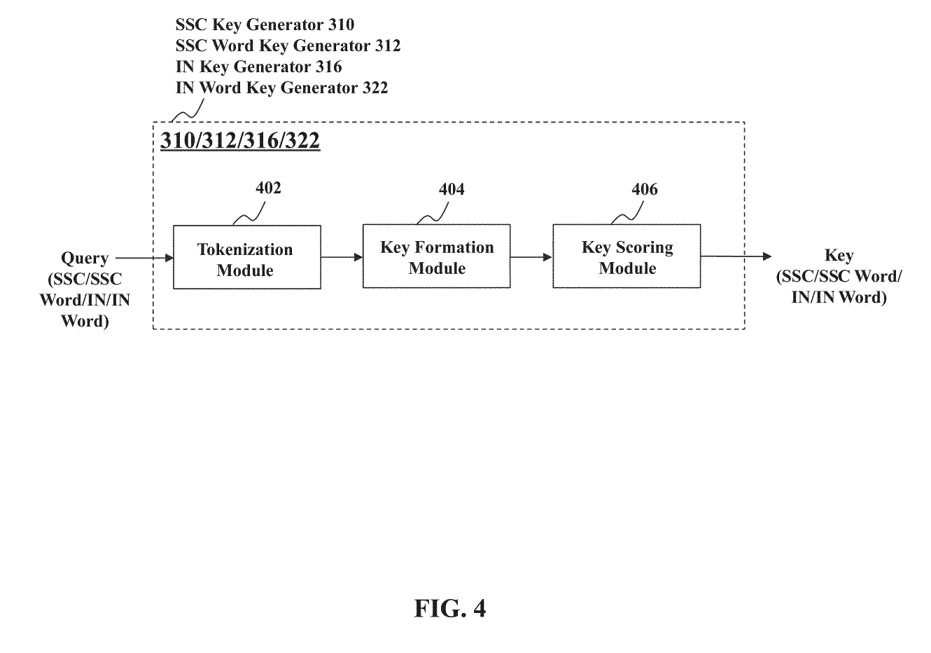

FIG. 4 depicts an exemplary diagram of a key generator, according to an embodiment of the present teaching. The key generator is responsible for processing a query to generate one or more keys, e.g., multi-layered keys. The structure and components of the key generator in FIG. 4 may be applicable in various contexts to process different types of queries, and depending on the context the key generator is applied, it may generate keys of different functions. The key generator may function as a part of the offline portion, i.e. as the SSC key generator 310 or as the SSC word key generator 312. Specifically, the key generator may function as the SSC key generator 310 that is responsible for processing a query of a search suggestion candidate to generate one or more SSC keys 304. The key generator may function as the SSC word key generator 312 that is responsible for processing a query of a SSC word to generate one or more SSC word keys 308. The key generator may function as a part of the online portion, i.e. as the input key generator 316 or as the input word key generator 322. Specifically, the key generator may function as the input key generator 316 that is responsible for processing a query of an input from a user (with or without a modification by way of, e.g., spelling correction) to generate one or more input keys. The key generator may function as the input word key generator 322 that is responsible for processing an input word to generate one or more input word keys. The key generator may include a tokenization module 402, a key formation module 404, and a key scoring module 406.

The tokenization module 402 is responsible for obtaining a query and processing the query to generate a plurality of tokens. When the key generator functions as a part of the offline portion, i.e. as the SSC key generator 310 or as the SSC word key generator 312, the processing of a query starts when the tokenization module 402 obtains a complete query, e.g., a complete search suggestion candidate, or a complete SSC word. When the key generator functions as the input key generator 316, the processing of an input starts when the tokenization module 402 obtains an input when, e.g., that a user presses a search button (or “Go,” or the like). If a search-as-you-type mechanism is employed, the processing of an input may start when a delimiter is detected or when the idle time exceeds a threshold. Exemplary delimiters include, e.g., a space, a punctuation mark (e.g., a period, a comma, a question mark, a colon, a semi colon, a hyphen, an underscore, or the like), a symbol (e.g., a dollar sign, a percent sign, an ampersand, a number sign, or the like), or the like. The idle time may refer to the time that the user waits after he enters the last part of the input. The threshold may be, e.g., 1 second, 2 seconds, 3 seconds, 4 seconds, 5 seconds, or the like. When the key generator functions as the input word key generator 322, the processing of an input word starts when the tokenization module 402 obtains an input word from, e.g., the spelling check engine 320.

The tokenization module 402 may process a query to generate one or more tokens using any known tokenization approaches, e.g., any one of those in natural language processing. For example, to segment a query into tokens, the tokenization module 402 may use any one of the following as a delimiter: a space, a punctuation mark (e.g., a period, a comma, a question mark, a colon, a semi colon, a hyphen, an underscore, or the like), a symbol (e.g., a dollar sign, a percent sign, an ampersand, a number sign, or the like). Merely by way of example, the tokenization module 402 treats a space as the delimiter, and the query including a pure ascii string “childhood obesity statistics” may be segmented into three tokens: childhood, obesity, and statistics.

The tokenization module 402 may process a query to generate one or more tokens of a certain length. If the query is a word, the tokenization module 402 may process the word and breaking it into one or more n-grams. The value n may be equal to or smaller than the length of the entire word. Consecutive n-grams may partially overlap, or may not overlap. As an example, the query “better” may be processed to generate 3-grams including: bet, ett, tte, and ter. In this example, consecutive 3-grams partially overlap. Alternatively, the same query “better” may be processed to generate 3-grams including: bet and ter. In this example, consecutive 3-grams do not overlap.

As to a query in a non-western language, the tokenization module 402 may treat a character as a token. Merely by way of example, the tokenization module 402 may process the query “2014 [symbol] ” to generate the following eight tokens: 2014, [symbol] [symbol] , [symbol] , [symbol] , [symbol] , [symbol] , and [symbol] .

According to an embodiment, a token may be evaluated based on one or more criteria before it is used to form a key. For example, prevalence of a token may be evaluated. If a token for a search suggestion candidate is very common (i.e. it is associated with a large number of search suggestion candidates in the SSC database 302), it would be inefficient to be used to form a SSC key 304. It would be inefficient in narrowing down search suggestions based on those SSC keys 304 including the token. In an embodiment, the prevalence of a token is evaluated based on whether the percentage of the search suggestion candidates in the SSC database 302 that include the token exceeds a threshold. In another embodiment, the prevalence of a token is evaluated based on whether the count of the search suggestion candidates in the SSC database 302 that include the token exceeds a threshold. The threshold may be chosen based on considerations including, e.g., the size of the SSC database 302, the desired retrieval time, the structure of SSC keys 304, or the like, or a combination thereof.

The key formation module 404 is responsible for forming a key based on one or more tokens of a query. A query may correspond to a plurality of keys. The key may be a multi-layered key. Merely by way of example, a multi-layered key of a query include one or more tokens of the query.

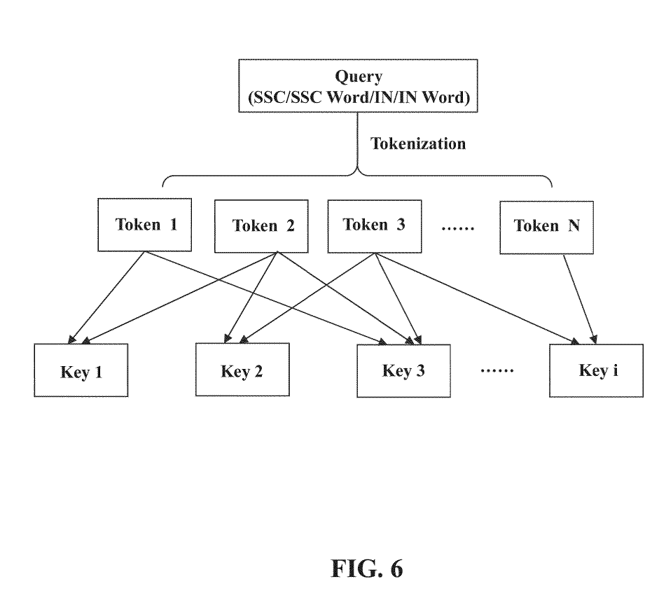

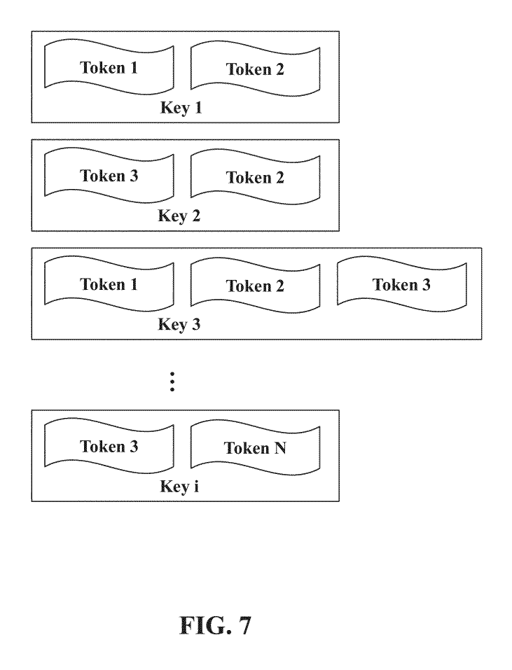

FIGS. 6 and 7 depict exemplary multi-layered keys, according to an embodiment of the present teaching. As illustrated in FIG. 6, a query may be a search suggestion candidate from the SSC database 302, a SSC word from the SSC database dictionary 306, an input from a user (with or without a modification by way of, e.g., spelling correction), or an input word. The query is processed by tokenization to generate Token 1, Token 2, Token 3, . . . Token N. A plurality of multi-layered keys are formed based on the tokens. Key 1 includes Token 1 and Token 2. Key 2 includes Token 2 and Token 3. Key 3 includes Token 1, Token 2, and Token 3. Key i includes Token 3 and Token N. These multi-layered keys are also illustrated in FIG. 7. According to an embodiment, a multi-layered key is characterized by the one or more tokens it includes, but not the order of the tokens. Accordingly, Key 3 including Token 3 followed by Token 2 is equivalent to a key including Token 2 followed by Token 3 (the latter not shown in FIG. 7). According to another embodiment, a multi-layered key is characterized not only by the one or more tokens it includes, but also the order of the tokens as they are arranged in the multi-layered key. Accordingly, Key 3 including Token 3 followed by Token 2 is different from a key including Token 2 followed by Token 3 (the latter not shown in FIG. 7).

For example, the query “childhood obesity statistics” may be segmented into three tokens: childhood, obesity, and statistics, as already discussed. Exemplary multi-layered keys including two tokens include “childhood obesity,” “childhood statistics,” and “obesity statistics,” as shown in Table 1. According to an embodiment, the order of the tokens is part of the characteristics of a multi-layered key, and additional exemplary multi-layered keys include “obesity childhood,” “statistics childhood,” and “statistics obesity,” not shown in Table 1.

The key formation module 404 may also process tokens in a non-western language. Also shown in Table 1 are exemplary multi-layered keys formed based on the query “2014 [symbol] ” discussed above.

TABLE 1

| Query | Token | Key |
|---|---|---|
| childhood obesity | childhood, obesity, | childhood obesity |
| statistics | statistics | childhood statistics |
| | | obesity statistics |
| 2014 [symbol] | 2014, [symbol] , [symbol] , [symbol] , [symbol] , | 2014 [symbol] |
| | [symbol] , [symbol] , [symbol] | 2014 [symbol] |
| | | 2014 [symbol] |
| | | 2014 [symbol] |
| | | 2014 [symbol] |
| | | 2014 [symbol] |
| | | 2014 [symbol] |
| | | [symbol] |
| | | [symbol] |

According to an embodiment, a multi-layered key for a query include 2 layers, a first layer and a second layer. The first layer includes one or more complete tokens and a partial token (that is a part of another token), and a second layer includes the other token from which the partial token in the first layer is taken. A m·n tokens indexing may refer to such a multi-layered key in which the first layer includes m complete tokens and n characters from another token, and the second layer includes the other token. E.g., if m and n are both equal to 1, the first layer includes a first token and a character of a second token, and the second layer includes the second token. Returning to the exemplary query “childhood obesity statistics,” Table 2 shows exemplary multi-layered keys constructed this way.

TABLE 2

| | | Key | |
|---|---|---|---|
| Query | Token | First layer | Second layer |
| childhood obesity | childhood, obesity, | Childhood o | obesity |
| statistics | statistics | Childhood s | statistics |
| | | Obesity s | statistics |

According to an embodiment, a query (e.g., an input word, a SSC word in the SSC database dictionary 306) may be processed to generate a plurality of tokens, each of which may include an n-gram. A multi-layered key of the query may include one or more n-grams. For example, a multi-layered key of the query may include two n-grams, three n-grams, four n-grams, or the like. Consecutive n-grams may overlap, or not. A multi-layered key of the query may include consecutive n-grams. Table 3 shows exemplary multi-layered keys, each including two 3-grams, for the query “better.” In this example, consecutive 3-grams partially overlap.

TABLE 3

| Query | Token | Key |
|---|---|---|
| better | bet, ett, tte, and ter | bet ett |
| | | ett tte |
| | | tte ter |

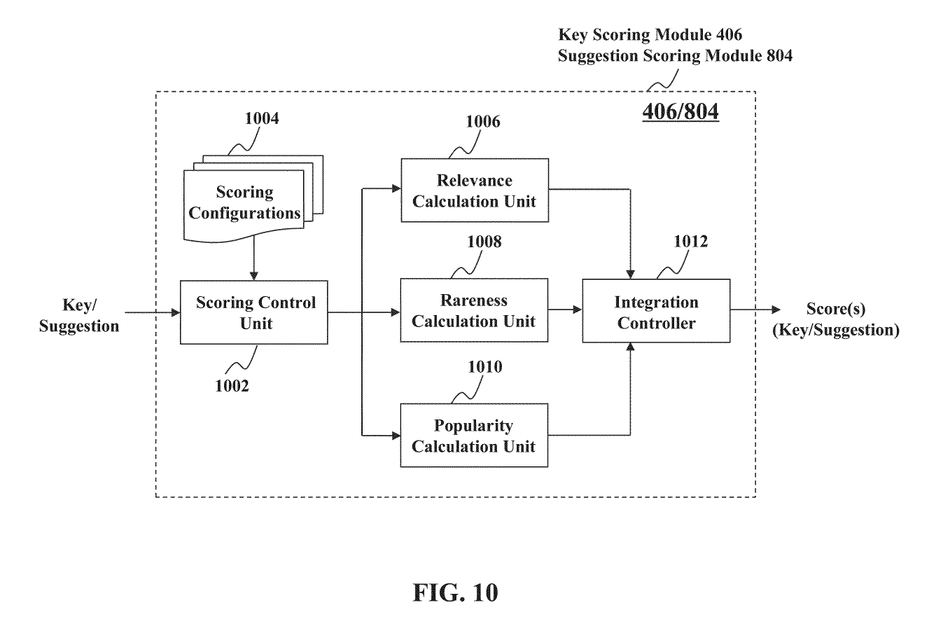

Returning to FIG. 4, the key generator may optionally include a key scoring module 406. The key scoring module 406 is responsible for calculating one or more parameters for a key formed by the key formation module 404. Parameters of a key may be calculated based on, e.g., rareness of the key, relevance between the key and the query, or the like, or a combination thereof. The key scoring module 406 is further described later with reference to FIG. 10. According to an embodiment, the key generator does not include a key scoring module 406.

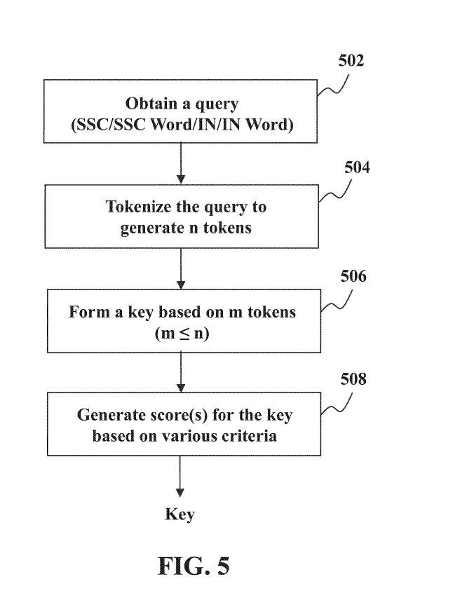

FIG. 5 depicts a flowchart of an exemplary process for generating a multi-layered key, according to an embodiment of the present teaching. Starting at 502, a query is obtained. The query may be a search suggestion candidate from the SSC database 302, a word suggestion from a SSC database dictionary 306, an input from a user (with or without a modification by way of, e.g., spelling correction), or an input word. At 504, the query is processed to generate n tokens. At 506, the tokens are used to form a key, e.g., a multi-layered key, including one or more (m) tokens. The value of m is smaller than or equal to the value of n. That is, the number of tokens involved in the key is not more than the total number of tokens generated based on the query. At 508, one or more parameters may be optionally calculated for the key based on at least one criterion including, e.g., rareness of the key, relevance between the key and the query, or the like, or a combination thereof. In some embodiments, step 508 may be skipped.

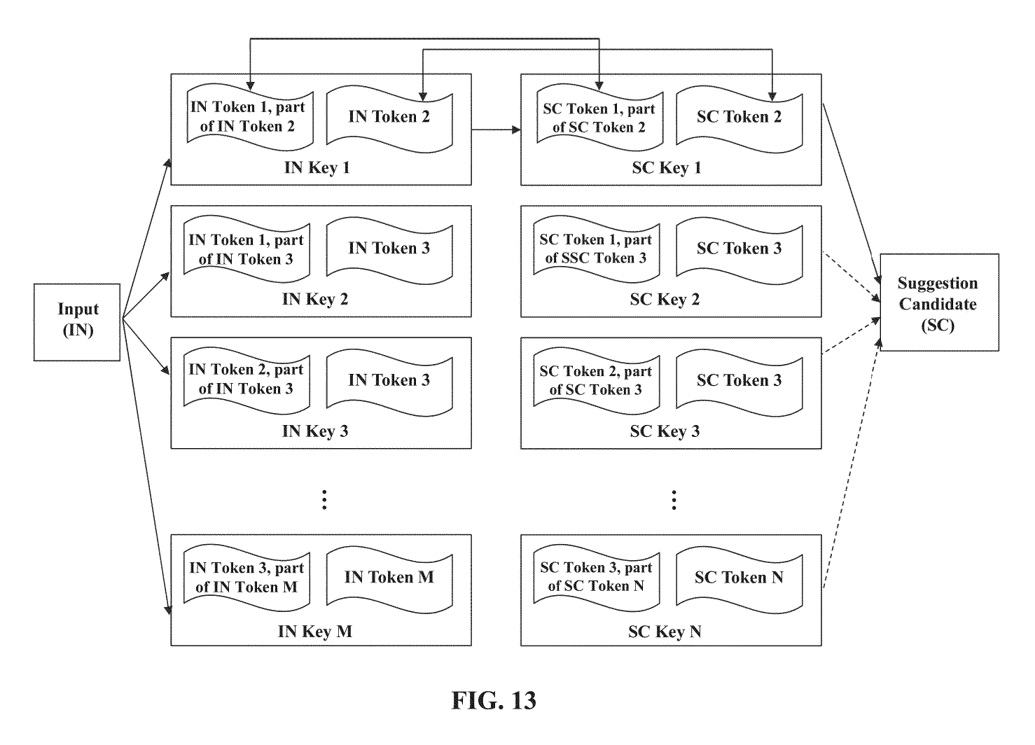

In the offline portion of the search suggestion engine 104, multi-layered keys may be stored in an index structure or a storage unit. For example, multi-layered SSC keys 304 may be stored in an index structure or a SSC key storage unit; multi-layered SSC word keys 308 may be stored in an index structure or a SSC word key storage unit. Multi-layered keys may be arranged, e.g., in alphabetic order. Merely by way of example, multi-layered keys as illustrated in FIG. 13 may be arranged as follows. The multi-layered keys are arranged in alphabetic order with respect to the first layer of the keys; under a same first layer, the multi-layered keys (sharing the same first layer) are arranged in alphabetic order with respect to the second layer of the keys.

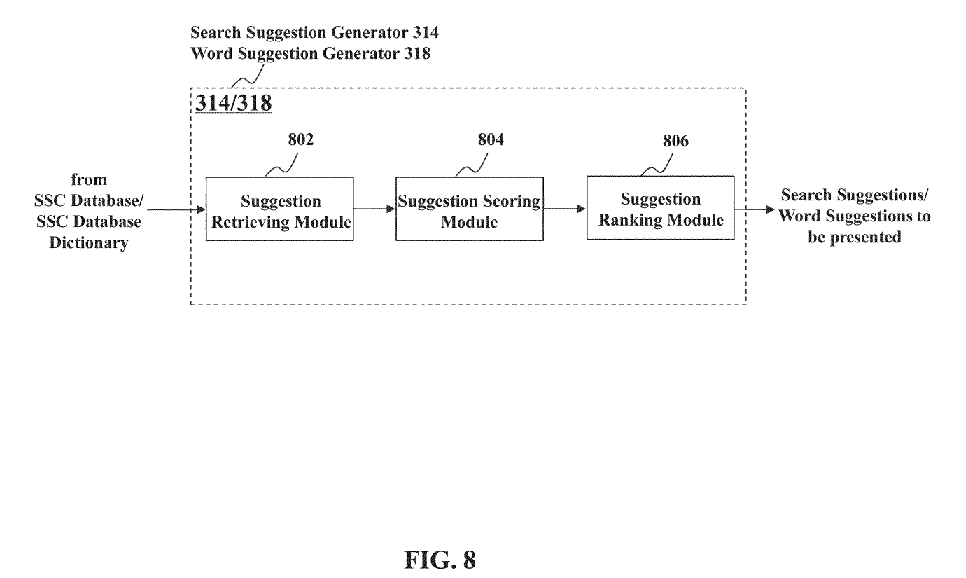

FIG. 8 depicts an exemplary diagram of a suggestion generator, according to an embodiment of the present teaching. The structure and the components of the suggestion generator in FIG. 8 may be applicable in the context of the search suggestion generator 314 responsible for retrieving search suggestions based on an input from a user from the SSC database 302, and also in the context of the word suggestion generator 318 responsible for retrieving word suggestions from the SSC database dictionary 306. A suggestion may be a search suggestion or a word suggestion. The suggestion generator may include a suggestion retrieving module 802, a suggestion scoring module 804, and a suggestion ranking module 806.

The suggestion retrieving module 802 is responsible for retrieving suggestions. When the suggestion generator functions as the search suggestion generator 314, the suggestion retrieving module 802 may retrieve search suggestions from the SSC database 302 based on the mapping between the input key(s) of an input (with or without a modification by way of, e.g., spelling correction) and the SSC key(s) of a search suggestion candidate of the SSC database 302. When the suggestion generator functions as the word suggestion generator 318, the suggestion retrieving module 802 may retrieve word suggestions from the SSC database dictionary 306 based on the mapping between the input word key(s) of an input word and the SSC word key(s) of a SSC word of the SSC database dictionary 306.

According to an embodiment, a suggestion is retrieved when one input key corresponds to one SSC key. According to another embodiment, a suggestion candidate is retrieved when a plurality of input keys correspond to a plurality of SSC keys. The number of the input keys of an input that correspond to the SSC keys of a search suggestion candidate may indicate relevance of the search suggestion candidate with respect to the input, even if correspondence of only one input key with one SSC key is sufficient to retrieve the search suggestion candidate. The descriptions are applicable to the situation in which a word suggestion is retrieved for an input word based on the mapping of the SSC word keys and the input word keys.

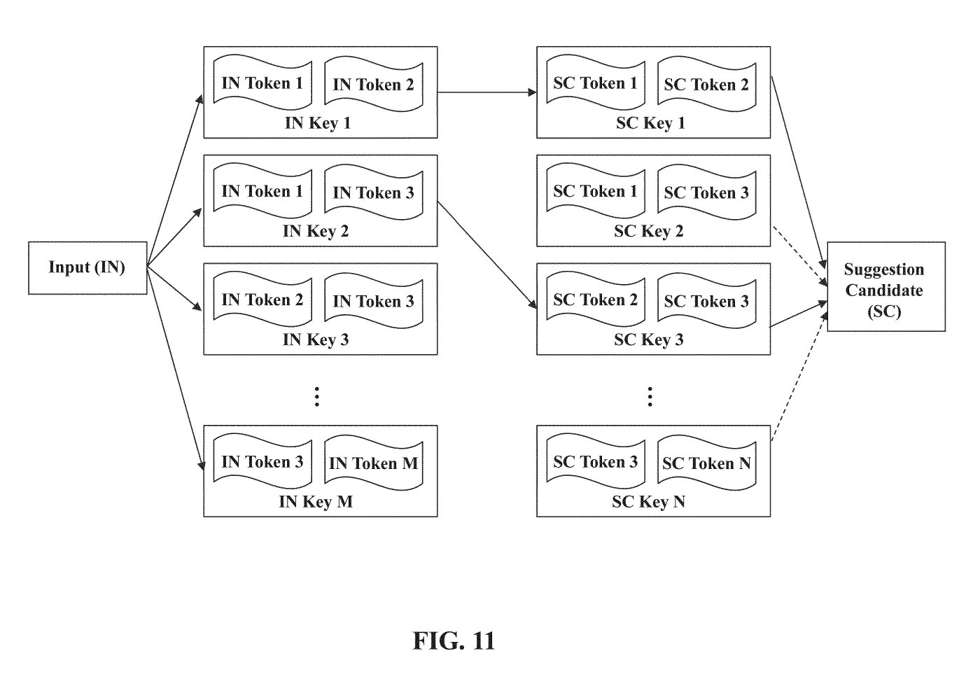

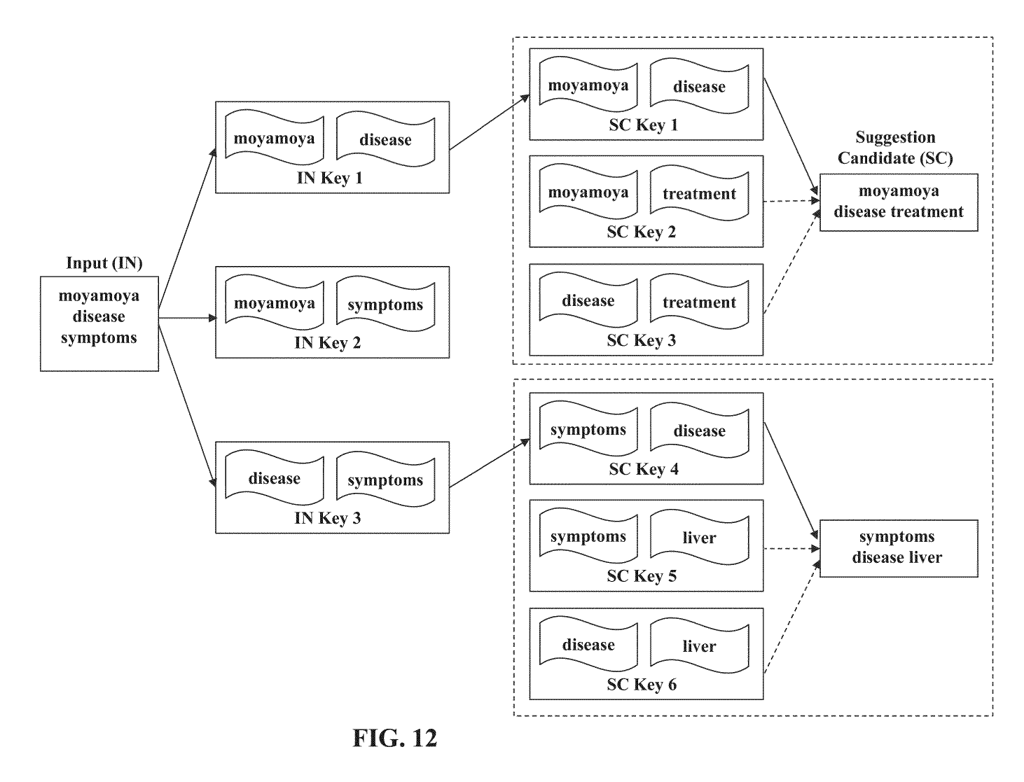

Exemplary methods of mapping are illustrated in FIGS. 11-15. FIGS. 11 and 12 depict an example of obtaining a suggestion candidate based on an input from a user (with or without a modification by way of, e.g., spelling correction) by mapping the multi-layered keys of the input with the multi-layered keys of the suggestion candidate, according to an embodiment of the present teaching. In the embodiment, a multi-layered key, either of an input (IN) or of a suggestion candidate, includes two tokens. An exemplary input (IN) is processed to generate a plurality of multi-layered IN keys, IN Key 1, IN Key 2, IN Key 3, . . . IN Key M. A suggestion candidate (SC) is associated with a plurality of multi-layered SC keys, SC Key 1, SC Key 2, SC Key 3, . . . SC Key N. The value of M may be the same as or different from the value of N. IN Key 1 of the input corresponds to SC Key 1 of the suggestion candidate. IN Key 2 of the input corresponds to SC Key 3 of the suggestion candidate.

According to an embodiment, correspondence between an input key and a SSC key indicates that IN Token 1 of IN Key 1 matches SC Token 1 of SC Key 1, and IN Token 2 of IN Key 1 matches SC Token 2 of SC Key 1. See, e.g., FIG. 12 in which IN Key 1 corresponds to SC Key 1. The match may be a perfect match, indicating that IN Token 1 is the same as SC Token 1. The match may be a relaxed match. For example, a word in a token may be considered to match an inflected form thereof. Accordingly, “cat” may be considered to match “cats”; “occur” may be considered to match “occurring; “catch” may be considered to match “caught.” As another example, two words (or a partial word and a word) may be considered to match if one is part of the other. For instance, “po” may be considered to match “poem” and “poverty”; “social” may be considered to match “antisocial.”

According to another embodiment, correspondence between an input key and a SSC key indicates that IN Token 1 of IN Key 1 matches one of SC Token 1 and SC Token 2 of SC Key 1, and IN Token 2 of IN Key 1 matches the other one of SC Token 1 and SC Token 2 of SC Key 1. Therefore, IN Key 1 is considered corresponding to SC Key 1 if IN Token 1 of IN Key 1 matches SC Token 2 of SC Key 1, and IN Token 2 of IN Key 1 matches SC Token 1 of SC Key 1. See, e.g., FIG. 12 in which IN Key 3 corresponds to SC Key 4. Although the difference in the order of the tokens in IN Key 1 from the order of the tokens in SC Key 1 does not destroy the correspondence between IN Key 1 and SC Key 1, the difference may be reflected in, e.g., relevance of the suggestion candidate with respect to the input.

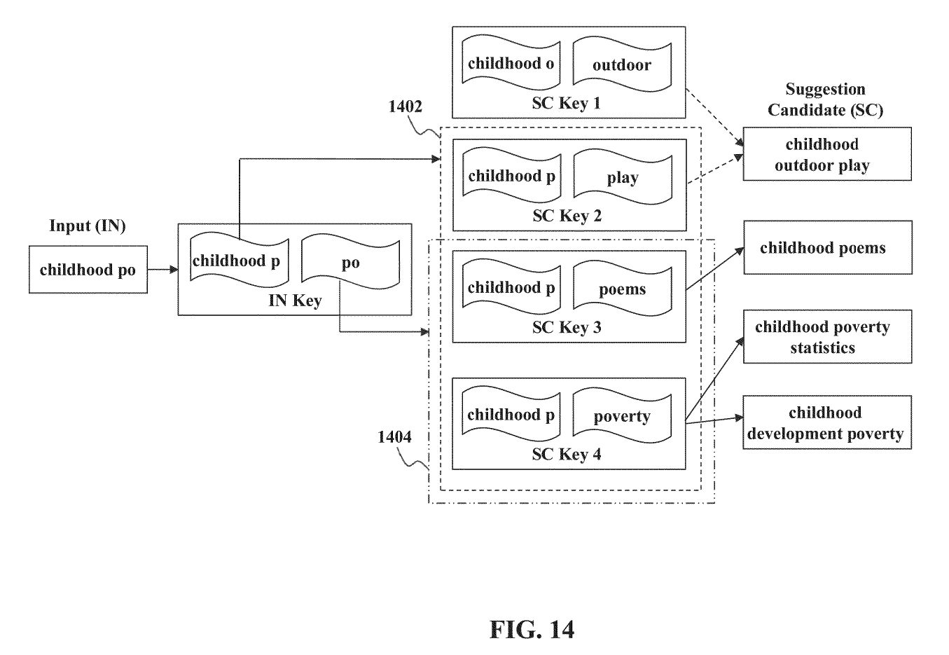

FIGS. 13 and 14 depict another example of obtaining a suggestion candidate based on an input from a user (with or without a modification by way of, e.g., spelling correction) by mapping the multi-layered keys of the input with the multi-layered keys of the suggestion candidate, according to an embodiment of the present teaching. In the embodiment, a multi-layered key, either of an input (IN) or of a suggestion candidate (SC), includes 2 layers, with a first layer including a complete token and a part of another token, and the second layer including the other token. An exemplary input is processed to generate a plurality of IN keys, IN Key 1, IN Key 2, IN Key 3, . . . IN Key M. In some embodiments, the last token in the input is used to provide the partial token in the first layer, and the token in the second layer. A suggestion candidate is associated with a plurality of SC keys, SC Key 1, SC Key 2, SC Key 3, . . . SC Key N. The value of M may be the same as or different from the value of N. IN Key 1 of the input corresponds to SC Key 1 of the suggestion candidate. Specifically, the first layer of IN Key 1 matches the first layer of SC Key 1, and the second layer of IN Key 1 matches the second layer of SC Key 1. The match between the first layer of IN Key 1 and the first layer of SC Key 1 may be a perfect match, or a reflexed match. The match between the second layer of IN Key 1 and the second layer of SC Key 1 may be a perfect match, or a reflexed match.

FIG. 14 illustrates an example of obtaining a suggestion candidate based on an input from a user by mapping the multi-layered keys of the input with the multi-layered keys of the suggestion candidate, according to the embodiment depicted in FIG. 13. The input “childhood po” may be processed to generate a multi-layered key, the first layer including “childhood p,” and the second layer including “po.” Four suggestion candidates (SCs) and their multi-layered keys are illustrated in FIG. 14. One suggestion candidate may have a plurality of SC keys. E.g., the suggestion candidate “childhood outdoor play” is associated with both SC Key 1 (“childhood o, outdoor”) and SC Key 2 (“childhood p, play”). Conversely, a SC key may be associated with a plurality of suggestion candidates. E.g., SC Key 4 (“childhood p, poverty”) is associated with two suggestion candidates, “childhood poverty” and “childhood development poverty.”

According to an embodiment, a series of multi-layered keys may be constructed based on a search suggestion candidate by varying n in the m·n tokens indexing. For instance, for the search suggestion candidate “childhood obesity school lunches,” the following series of multi-layered keys may be constructed: childhood o, childhood ob, childhood obe, childhood obes, childhood obesi, childhood obesit, childhood obesity, childhood s, childhood sc, . . . .

To retrieved suggestions, the multi-layered IN keys of the input are used to map with the multi-layered SC keys of suggestion candidates. The first layer of the multi-layered IN key is used to search for a group of SC keys that have a corresponding first layer. The group of SC keys in turn are associated with a group of suggestion candidates. As illustrated in FIG. 14, the first layer of the IN Key corresponds to the first layer of a group of SC keys 1402, the group 1402 including SC Key 2, SC Key 3, and SC Key 4; the group of SC keys 1402 are associated with all four suggestion candidates listed in FIG. 14. Then the second layer of the multi-layered IN key is used to search, within the group of SC keys, for a sub-group of SC keys that have a corresponding second layer. The sub-group of SC keys are associated with the suggestions to be retrieved. As illustrated in FIG. 14, the second layer of the IN key corresponds to the second layer of a sub-group of SC keys 1404, the sub-group 1404 including SC Key 3 and SC Key 4; the sub-group of SC keys 1404 are associated with three of the four suggestion candidates listed in FIG. 14, and the three suggestions are retrieved. As already discussed, the correspondence may indicate perfect match or relaxed match.

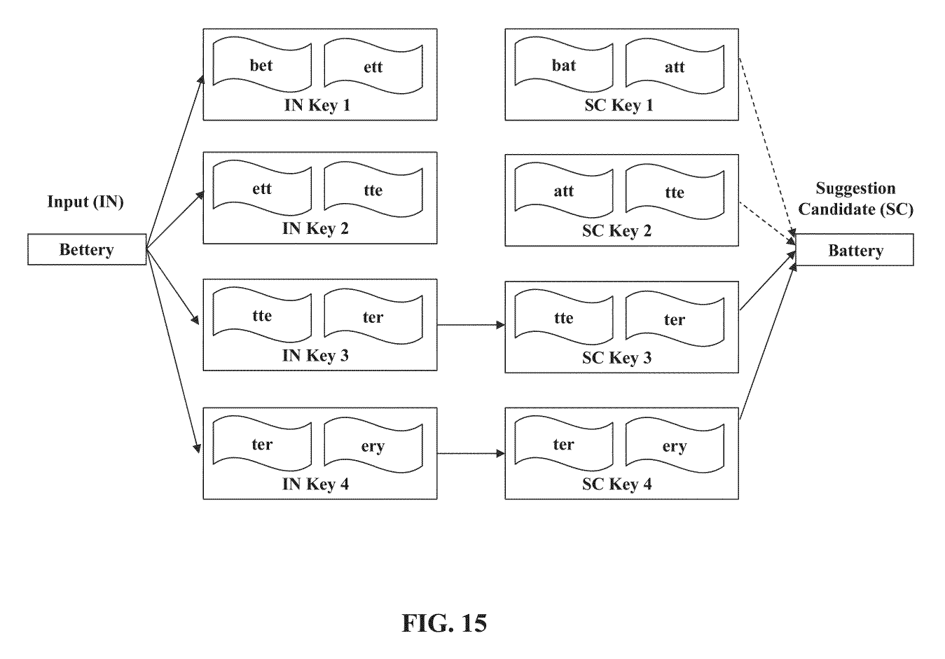

FIG. 15 depicts an example of obtaining a word suggestion based on an input word by mapping the multi-layered keys of an input word with the multi-layered keys of a suggestion candidate (a word suggestion), according to an embodiment of the present teaching. In the embodiment, a multi-layered key, either of the input (IN) word or of a word suggestion, includes two tokens. Each token corresponds to a 3-gram. Each multi-layered key is based on two consecutive 3-grams. The input word “battery” is processed to generate a plurality of multi-layered IN keys, IN Key 1, IN Key 2, IN Key 4. The word suggestion “battery” is associated with a plurality of multi-layered SC keys, SC Key 1, SC Key 2, SC Key 3, and SC Key 4. The word suggestion is retrieve because IN Key 3 and IN Key 4 of the input word correspond to SC Key 3 and SC Key 4 of the word suggestion, respectively.

Returning to FIG. 8, the suggestion generator optionally includes the suggestion scoring module 804 responsible for calculating a score for a suggestion retrieved by the suggestion retrieving module 802. More descriptions regarding the suggestion scoring module 804 are described below with reference to FIG. 10.

FIG. 10 depicts an exemplary diagram of a scoring module, according to an embodiment of the present teaching. The structure and the components of the scoring module in FIG. 10 may be applicable in the context of the key scoring module 406 responsible for calculating parameters for keys (e.g., SSC keys 304 or SSC word keys 308) (as a part of the offline portion of the search suggestion engine 104), and also in the context of the suggestion scoring module 804 responsible for calculating scores for suggestions (e.g., search suggestions or word suggestions) (as a part of the online portion of the search suggestion engine 104). The scoring module may include a scoring control unit 1002, scoring configurations 1004, a relevance calculation unit 1006, a rareness calculation unit 1008, a popularity calculation unit 1010, and an integration controller 1012.

Various rules for calculating parameters and scores of a suggestion may be stored in the scoring configurations 1004. Specific rules applicable in a specific context may be retrieved by the scoring control unit 1002. The scoring module is described in the context of its application in calculating scores for search suggestions retrieved from the SSC database 302 based on one or more multi-layered SSC keys 304 and one or more multi-layered input keys of an input. In this context, the score module may have an offline aspect and an online aspect.

The score of a search suggestion with respect to an input may be based on one or more criteria. Possible criteria may include, for example, rareness of a SSC key 304 through which the search suggestion is retrieved, relevance between the search suggestion and the input, or the like, or a combination thereof. Additional criterion may include, for example, popularity of the search suggestion.

As to the offline aspect of the scoring module, some parameters of a search suggestion depend on the SSC database 302 itself, but not a specific input from a user. Such parameters may be calculated offline and provided with the search suggestion when it is retrieved, thereby reducing the consumption of time and/or resources in a real-time online search. Described below are exemplary parameters that belong to this category including, e.g., the rareness of a SSC key 304 in the SSC database 302, the word gap of tokens of a SSC key 304 in a search suggestion candidate, or the like.

Rareness of a SSC key 304 relates to the number of search suggestion candidates in the SSC database 302 correspond to the SSC key 304. That a SSC key 304 is rare in the SSC database 302 indicates that the SSC key 308 is associated with a small number of search suggestion candidates in the SSC database 302. A rare SSC key 304 may lead to that a small number of search suggestions are retrieved, thereby providing efficient search assistance. A positive consideration proffered to the parameter may compensate, to some extent, that a rare SSC key 304 may be associated with a search suggestion candidate that is unpopular among general users.

Rareness calculation unit 1008 is responsible for calculating the rareness parameter for a SSC key 304. The rareness of the SSC key 304 may be determined if the size of the SSC database 302 (i.e. the total number of search suggestion candidates in the SSC database 302) and the SSC keys 304 of the search suggestion candidates in the SSC database 302 are known. Merely by way of example, rareness of a SSC key 304 may be calculated as follows:

Rareness(k_i)=ln((TN−d_i+c)/(d_i+c)), (1)

in which k_i stands for the ith SSC key 304 of a search suggestion candidate, ln is the natural logarithm, TN the total number of search suggestion candidates in the SSC database 302 (i.e. the size of the SSC database 302), d_i the frequency of the ith SSC key 304 in the SSC database 302 (i.e. the number of search suggestion candidates in the SSC database 302 that include the ith SSC key), and c is a constant (e.g., c=0.5). It is understood that equation (1) is provided for illustration purposes and not intended to limit the scope of the present teaching. Rareness of a SSC key 304 may be assessed using other methods. The rareness of a SSC key 304 may be calculated offline, and may be stored in, e.g., the SSC key storage unit, and with the SSC key 304.

Relevance of a search suggestion with respect to an input may be evaluated based on, e.g., lexical similarity between them. Lexical similarity, in turn, may be assessed by, e.g., comparing tokens and their positions in the search suggestion with those in the input. The relevance calculation unit 1006 is responsible for calculating the relevance parameter.

According to an embodiment, the search suggestion is retrieved when a multi-layered SSC key 304 of the search suggestion corresponds to a multi-layered input key of the input, indicating that the tokens of the multi-layered SSC key 304 correspond to the tokens of the multi-layered input key (e.g., by way of a perfect match or a relaxed match). The positions of the tokens of the multi-layered SSC key 304 in the search suggestion may be assessed based on, e.g., adjacency or word gap between the tokens of the multi-layered SSC key 304 in the search suggestion. The word gap may indicate the difference in word positions. Merely by way of example, in the search suggestion candidate (referred to as “suggestion candidate” or “SC” in FIG. 12 for brevity) “symptoms disease liver” shown in FIG. 12, SC Key 4 includes two tokens, “symptoms” and “disease,” and the word gap between the two tokens in the search suggestion candidate is 1, as calculated as follows. Assuming that the position of the token “symptoms” in the search suggestion candidate is 0, the position of the token “disease” is 1, and the word gap of the two tokens of SC Key 5 in the search suggestion candidate is 1-0, equal 1. SC Key 5 includes two tokens, “symptoms” and “liver,” and the word gap between the two tokens in the search suggestion candidate is calculated to be 2. The word gap of the tokens of a SSC key 304 may be calculated offline, and may be stored in, e.g., the SSC key storage unit, and with the SSC key 304 associated with the search suggestion candidate.

The positions of the tokens of a SSC key 304 in the input may be calculated online in a similar manner. According to an embodiment, the order of the tokens in an input and in a search suggestion candidate is considered. This may be achieved by allowing a negative word gap. Returning to the example in FIG. 12, in the input “moyamoya disease symptoms,” assuming that the position of the token “moyamoya” is 0, the position of the token “disease” is 1 and the position of the token “symptoms” 2, and the word gap of the two tokens of SC Key 4 in the input is 1-2, equal −1. According to another embodiment, the order of the tokens in an input compared to that in a search suggestion candidate is not considered. Then there is no need to consider a negative word gap. Accordingly, the word gap of the two tokens of SC Key 4 in the input is 1.

These results regarding the positions of the tokens of a SSC key 304 in both the search suggestion candidate and the input may be compared to assess relevance of the search suggestion and the input. The comparison may be achieved using, e.g., a parameter referred to as “adjacency.” The value of adjacency with respect to the ith SSC key 304 in the search suggestion and the input may be calculated based on the word gap information as follows:

Adjacency(k_i)=a/(1+abs(s_i−in_i)), (2)

in which a is a base value for adjacency (e.g., a=10), s_i is the word gap of the tokens of the ith SSC key 304 in the search suggestion s, and in_i is the word gap of the tokens of the ith SSC key 304 in the input, abs is the absolute function. It is understood that equation (2) is provided for illustration purposes and not intended to limit the scope of the present teaching. Adjacency of a SSC key 304, as well as the relevance of a search suggestion with respect to an input, may be assessed using other methods.

The score of a search suggestion with respect to an input may be based on additional criteria including, for example, popularity of the search suggestion. The popularity of a search suggestion may be assessed in terms of the number of time it is provided or searched within a period of time. The popularity may be based on search behavior of general public users, a specific group of users, or a specific user. The information may be obtained from, e.g., a query log database, the SSC database 302, or the like. The information may be processed in the popularity calculation unit 1010.

If multiple criteria are used to calculate the score, their contribution to the score may be reflected by assigning different weights to these criteria. The weights assigned to different criteria may be chosen based on the relative effects of the criteria on the likelihood a search suggestion is the one desired by the user. The weights may be set based on historical data, and may be adjusted if needed. Merely by way of example, a score with respect to a search suggestion (s) and an input (in) may be calculated as follows:

Score(s,in)=w_r*sum{i=1,n}(rareness(k_i)*adjacency(k_i))+w_p*popularity(s), (3)

in which w_r is the weight assigned to the combination of rareness and adjacency, n is the number of SSC keys associated with the search suggestion s, w_p is the weight assigned to the popularity(s) of the search suggestion s. To facilitate comparison of the scores of different search suggestions with respect to the same input, the values of rareness(k_i), adjacency(k_i), and/or popularity(s) may be normalized. For example, rareness(k_i) may be normalized with respect to, e.g., the maximum value thereof among the search suggestions to be compared. The values of other parameters may be normalized similarly.

It is understood that equation (3) is provided for illustration purposes and not intended to limit the scope of the present teaching. There are other ways to calculate a score with respect to a search suggestion (s) and an input (in). The score may be calculated in the integration controller 1012.

The following example is provided to further illustrate how the parameters and scores are calculated. It is understood that the example is for illustration purposes, and not intended to limit the scope of the present teaching.

Assume that the SSC database 302 includes 20,000,000 search suggestion candidates (i.e. N=20,000,000). Shown in Table 4 is a portion thereof relevant to the example, as well as their IDs within the SSC database 302, and their respective popularity (in terms of their respective occurrences).

TABLE 4

| ID | Search Suggestion Candidate | Occurrence |
|---|---|---|
| 0 | liver disease symptoms | 258091 |
| 1 | crohn disease symptoms | 158306 |
| 2 | heart disease symptoms | 1363 |
| 3 | moyamoya disease | 90 |
| 4 | moyamoya disease treatment | 3 |
| 5 | symptoms moyamoya disease | 2 |
| 6 | symptoms crohn disease | 1001 |
| 7 | symptoms liver disease | 999 |

The SSC key generator 310, a part of the offline portion of the search suggestion engine 104, constructs multi-layered SSC keys 304 including two tokens, and calculates the frequency of the SSC keys 304 (i.e. the number of search suggestion candidates in the SSC database 302 that include the SSC keys 304), and word gaps of the SSC keys 304 in the corresponding search suggestion candidates. The results are summarized in Table 5.

TABLE 5

| SSC Key | Frequency of SSC Key | SSC ID:Word Gap |
|---|---|---|
| moyamoya disease | 3 | 3:1, 4:1, 5:1 |
| Disease symptoms | 382 | 0:1, 1:1, 2:1, 5:−2, |
| | | 6:−2, 7:−2 |
| Liver disease | 44 | 0:1, 7:1 |
| crohn disease | 128 | 1:1, 6:1 |
| heart disease | 254 | 2:1 |
| moyamoya treatment | 1 | 4:2 |
| disease treatment | 175 | 4:1 |

Resorting to the online portion of the search suggestion engine 104, assume that the input is “moyamoya disease symptoms.” The input key generator 316 may process the input in a manner that essentially mirrors the manner the SSC key generator 310 generates the SSC keys 304 shown in Table 5. The input keys are shown in Table 6.

TABLE 6

| Input | Token | Input Key |
|---|---|---|
| moyamoya disease | moyamoya, disease, | moyamoya disease |
| symptoms | symptoms | moyamoya symptoms |
| | | disease symptoms |

Search suggestions may be retrieved based on the number of SSC keys 304 shared by the input and the search suggestion candidates. If the threshold for the number is set to be 1, all those shown in Table 4 may be retrieved.

The search suggestion “liver disease symptoms” has three SSC keys, “liver disease,” “liver symptoms,” and “disease symptoms,” as shown in Table 7.

As to the SSC key “liver symptoms,” its frequency in the SSC database 302 is 44, as shown in Table 5. The rareness of the SSC key, calculated based on equation (1), is 13.02. This SSC key does not match any one of three input keys of the input. Accordingly, the adjacency, calculated based on equation (2), is 0, assuming that in_i, the word gap of the tokens thereof in the input, is infinity. Repeating these steps for the other two SSC keys, “liver symptoms” and “disease symptoms” using the data in Table 5 and equations (1) and (2), and then calculating the sum of the products of the rareness and the adjacency, sum{i=1, n}(rareness(k_i)*adjacency(k_i)) as shown in equation (3), the results are summarized in Table 7.

Then repeating the procedure for the other search suggestions using the data in Table 5 and equations (1), (2) and (3), the results are also summarized in Table 7. In this example, the SSC key “disease symptoms” is considered to correspond to the input key “symptoms disease.” The reverse orders of the two tokens in these two keys are accounted in the calculations of the word gaps which in turn are rolled into the calculation of adjacency.

TABLE 7

| Search Suggestion | SSC Key | Rareness | Adjacency | Sum | Occurrence | Score |
|---|---|---|---|---|---|---|
| liver disease symptoms | liver disease | 13.02 | 0 | 108.6 | 258091 | 0.74 |
| | live symptoms | 15.89 | 0 | | | |
| | disease symptoms | 10.86 | 10 | | | |
| crohn disease symptoms | crohn disease | 11.96 | 0 | 108.6 | 158306 | 0.55 |
| | crohn symptoms | 13.95 | 0 | | | |
| | disease symptoms | 10.86 | 10 | | | |
| heart disease symptoms | heart disease | 11.27 | 0 | 108.6 | 1363 | 0.25 |
| | heart symptoms | 11.76 | 0 | | | |
| | disease symptoms | 10.86 | 10 | | | |
| moyamoya disease | moyamoya disease | 15.56 | 10 | 155.6 | 90 | 0.35 |
| moyamoya disease treatment | moyamoya disease | 15.56 | 10 | 155.6 | 3 | 0.35 |
| | moyamoya treatment | 16.41 | 0 | | | |
| | disease treatment | 11.64 | 0 | | | |
| symptoms moyamoya disease | symptoms moyamoya | 16.41 | 2.5 | 223.78 | 2 | 0.50 |
| | symptoms disease | 10.86 | 2.5 | | | |
| | moyamoya disease | 15.56 | 10 | | | |
| symptoms crohn disease | symptoms crohn | 13.94 | 0 | 27.15 | 1001 | 0.06 |
| | symptoms disease | 10.86 | 2.5 | | | |
| | crohn disease | 11.96 | 0 | | | |
| symptoms liver disease | symptoms liver | 15.89 | 0 | 27.15 | 999 | 0.06 |
| | symptoms disease | 10.86 | 2.5 | | | |
| | liver disease | 13.02 | 0 | | | |

The results in Table 7 show that if a SSC key of a retrieved search suggestion does not match any one of the input keys of an input, the adjacency value calculated using the exemplary method is zero. According to an embodiment, such a SSC key is skipped in the calculation, thereby reducing the volume of the calculation that need to be done, and also the consumption of time and resources for a real-time online search.

The integration controller 1012 may process the values from the various calculation units to calculate a score. Return to the example regarding the search suggestions for the input “moyamoya disease symptoms.” To facilitate the comparison of the scores of the search suggestions, the value of the sum for each search suggestion is normalized based on the maximum value of 223.78, and the occurrence for each search suggestion is normalized based on the maximum value of 258091. Assuming that each of the weight w_r and the weight w_p in equation (3) is 0.5, the scores of the search suggestion may be calculated using equation (3), and the results are summarized in Table 7.

The application of the scoring module in other contexts in the search suggestion engine 104 would be similar. According to an embodiment, some but not all the calculation units depicted in FIG. 10, the relevance calculation unit 1006, the rareness calculation unit 1008, and the popularity calculation unit 1010, may be skipped. For example, for the key scoring module 406, the popularity calculation unit 1010 may be skipped. According to an embodiment, the parameters from different calculation units are output without being integrated. For example, for the key scoring module 406, the values of rareness and of the word gap for a SSC key 304 may be output to be stored in the SSC key storage unit, associated with the SSC key 304 without being integrated to a single score. According to an embodiment, there is no need to calculate a score of a suggestion (e.g., a word suggestion or a search suggestion), and the suggestion scoring module 804 is omitted or bypassed.

Returning to FIG. 8, after suggestions are scored, they may be ranked by the suggestion ranking module 806. The ranking may be based on, e.g., the scores calculated in the suggestion scoring module 804. Returning to the example regarding the search suggestions for the input “moyamoya disease symptoms,” based on the scores summarized in Table 7, the search suggestions may be ranked. According to an embodiment, there is no need to rank a suggestion (e.g., a word suggestion or a search suggestion), and the suggestion ranking module 806 is omitted or bypassed.

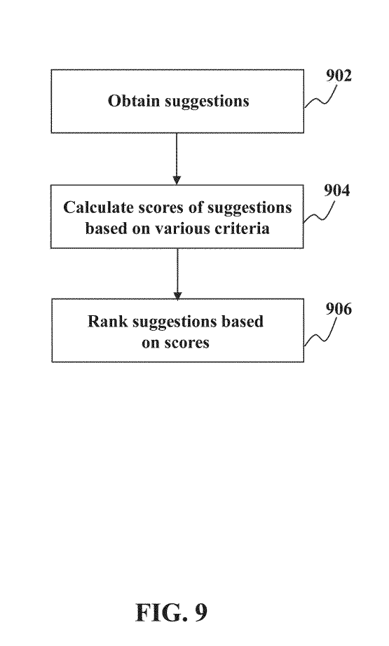

FIG. 9 depicts a flowchart of an exemplary process for generating suggestions. Starting at 902, one or more suggestions are obtained. The one or more suggestions may be search suggestions obtained from a SSC database 302, or word suggestions obtained from SSC database dictionary 306. At 904, scores of the one or more suggestions are calculated based on one or more criteria. In some embodiments, the step 904 may be skipped, and no scores calculated. At 906, the one or more suggestions are ranked. The ranking may be performed based on the scores calculated at 904, or based on other criteria. In some embodiments, the step 906 may be skipped, and no ranking performed. Merely by way of example, in the SSC key generator 310, various parameters of a SSC key are calculated in the key scoring module 406, and are stored. However, no ranking of SSC keys are performed based on the calculated parameters.

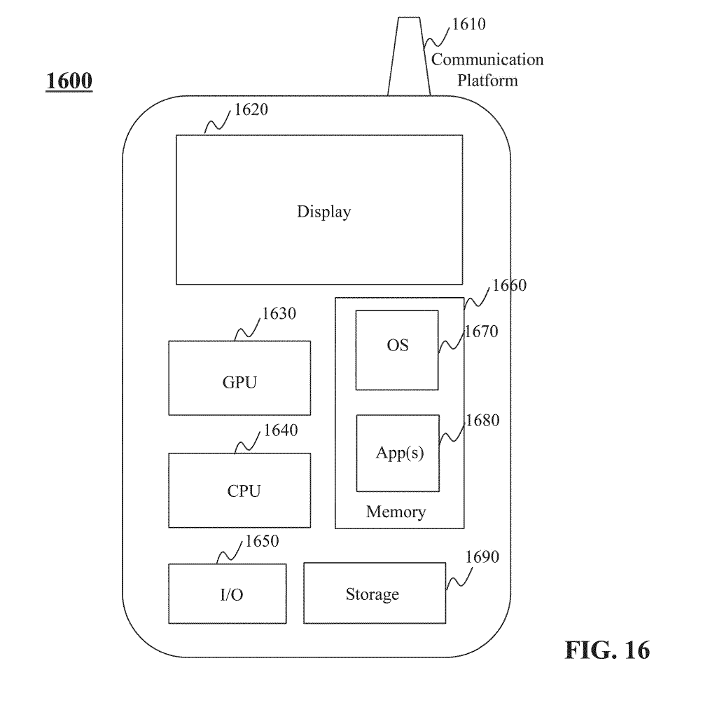

FIG. 16 depicts the architecture of a mobile device which can be used to realize a specialized system implementing the present teaching. In this example, the user device on which suggestions and content are presented and interacted—with is a mobile device 1600, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1600 in this example includes one or more central processing units (CPUs) 1640, one or more graphic processing units (GPUs) 1630, a display 1620, a memory 1660, a communication platform 1610, such as a wireless communication module, storage 1690, and one or more input/output (I/O) devices 1650. Any other suitable component, including but not limited to a system bus or a controller (not shown), may also be included in the mobile device 1600. As shown in FIG. 16, a mobile operating system 1670, e.g., iOS, Android, Windows Phone, etc., and one or more applications 1680 may be loaded into the memory 1660 from the storage 1690 in order to be executed by the CPU 1640. The applications 1680 may include a browser or any other suitable mobile apps for receiving and rendering suggestions and content streams on the mobile device 1600. User interactions with the suggestions and content streams may be achieved via the I/O devices 1650 and provided to the search serving engine 102 and/or the search suggestion engine 104 and/or other components of system 100, e.g., via the network 112.

To implement various modules, units, and their functionalities described in the present disclosure, computer hardware platforms may be used as the hardware platform(s) for one or more of the elements described herein (e.g., the search serving engine 102, the search suggestion engine 104, and/or other components of system 100 described with respect to FIGS. 1-15). The hardware elements, operating systems and programming languages of such computers are conventional in nature, and it is presumed that those skilled in the art are adequately familiar therewith to adapt those technologies to indexing and providing suggestions as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

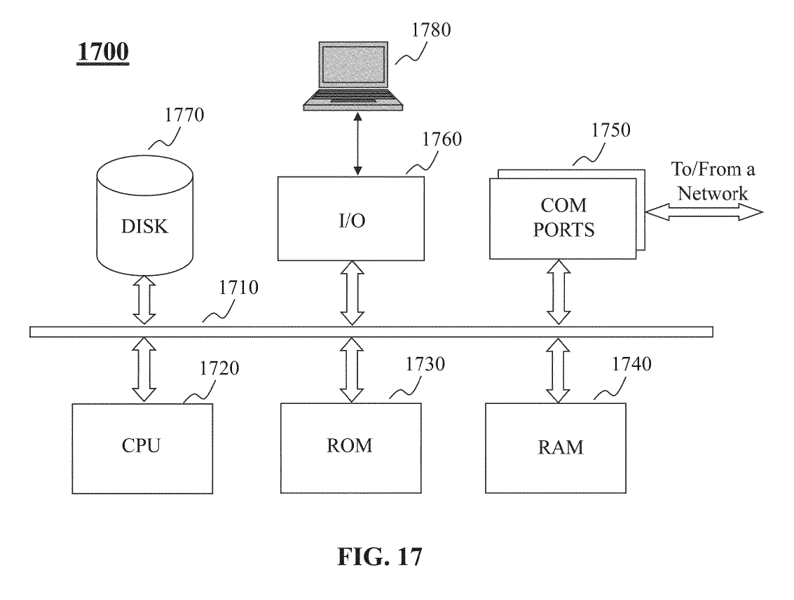

FIG. 17 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1700 may be used to implement any component of indexing and providing suggestions as described herein. For example, the search suggestion engine 104, etc., may be implemented on a computer such as computer 1700, via its hardware, software program, firmware, or a combination thereof. Although only one such computer is shown, for convenience, the computer functions relating to indexing and providing suggestions as described herein may be implemented in a distributed fashion on a number of similar platforms, to distribute the processing load.

The computer 1700, for example, includes COM ports 1750 connected to and from a network connected thereto to facilitate data communications. The computer 1700 also includes a central processing unit (CPU) 1720, in the form of one or more processors, for executing program instructions. The exemplary computer platform includes an internal communication bus 1710, program storage and data storage of different forms, e.g., disk 1770, read only memory (ROM) 1730, or random access memory (RAM) 1740, for various data files to be processed and/or communicated by the computer, as well as possibly program instructions to be executed by the CPU. The computer 1700 also includes an I/O component 1760, supporting input/output flows between the computer and other components therein such as user interface elements 1780. The computer 1700 may also receive programming and data via network communications.

Hence, aspects of the methods of enhancing ad serving and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors, or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator or other search assistance into the hardware platform(s) of a computing environment or other system implementing a computing environment or similar functionalities in connection with enhancing search assistance. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the search assistance including indexing and providing suggestions as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on at least one machine each of which has at least one processor, storage, and a communication platform connected to a network for providing a suggestion, the method comprising:
receiving an input from a user;
processing at least a part of the input to generate a plurality of tokens;
generating at least one multi-layered key based on one or more of the plurality of tokens;
retrieving, based on the at least one multi-layered key, one or more suggestions; and
providing at least one of the one or more suggestions to be presented to the user.

2. The method of claim 1, wherein the at least one multi-layered key includes two layers with a first layer comprising a first token and a part of a second token, and a second layer comprising the second token.

3. The method of claim 2, wherein the step of retrieving comprises:
obtaining, based on the first layer of the at least one multi-layered key, a group of suggestion candidates; and
retrieving, based on the second layer of the at least one multi-layered key, the one or more suggestions from the group.

4. The method of claim 1, wherein each of the plurality of tokens corresponds to an n-gram extracted from the at least a part of the input.

5. The method of claim 4, wherein consecutive n-grams partially overlap.

6. The method of claim 4, wherein the at least one multi-layered key comprises a plurality of consecutive n-grams.

7. The method of claim 1, further comprising:
calculating a score for each of the one or more suggestions based on at least one criterion; and
ranking the one or more suggestions based on the scores.

8. The method of claim 7, wherein the at least one criterion is based on at least one of relevance between the input and a suggestion and rareness of the at least one multi-layered key.

9. A system having at least one processor, storage, and a communication platform for providing a suggestion, the system comprising:
a tokenization module configured to process at least a part of an input from a user to generate a plurality of tokens;
a key formation module configured to form at least one multi-layered key based on one or more of the plurality of tokens; and
a suggestion generator configured to retrieve, based on the at least one multi-layered key, one or more suggestions.

10. The system of claim 9, wherein the at least one multi-layered key includes two layers with a first layer comprising a first token and a part of a second token, and a second layer comprising the second token.

11. The system of claim 10, wherein the suggestion generator comprises a suggestion retrieving module configured to
obtain, based on the first layer of the at least one multi-layered key, a group of suggestion candidates; and
retrieve, based on the second layer of the at least one multi-layered key, the one or more suggestions from the group.

12. The system of claim 9, wherein each of the plurality of tokens corresponds to an n-gram extracted from the at least a part of the input, and the key formation module is configured to form the at least one multi-layered key based on a plurality of consecutive n-grams.

13. The system of claim 10, wherein the suggestion generator comprises
a suggestion scoring module configured to calculate a score for each of the one or more suggestions based on at least one criterion; and
a suggestion ranking module configured to rank the one or more suggestions based on the scores.

14. The system of claim 13, wherein the at least one criterion is based on at least one of relevance between the input and a suggestion and rareness of the at least one multi-layered key.

15. A method, implemented on at least one machine each of which has at least one processor, storage, and a communication platform connected to a network for maintaining a suggestion candidate database, the method comprising:
obtaining a suggestion candidate;
processing at least a part of the suggestion candidate to generate a plurality of tokens;
generating at least one multi-layered key based on one or more of the plurality of tokens;
associating the at least one multi-layered key with the suggestion candidate; and
storing the suggestion candidate and the at least one multi-layered key.

16. The method of claim 15, wherein the at least one multi-layered key includes two layers with a first layer comprising a first token and a part of a second token, and a second layer comprising the second token.

17. The method of claim 15, wherein each of the plurality of tokens corresponds to an n-gram extracted from the at least a part of the suggestion candidate.

18. The method of claim 17, wherein consecutive n-grams partially overlap.

19. The method of claim 17, wherein the at least one multi-layered key comprises a plurality of consecutive n-grams.

20. The method of claim 15 further comprising calculating at least one parameter of the at least one multi-layered key in the suggestion candidate database.

21. The method of claim 20, wherein the at least one parameter is based on at least one of relevance between the at least one multi-layered key and the suggestion candidate and rareness of the at least one multi-layered key.

22. A system having at least one processor, storage, and a communication platform for maintaining a suggestion candidate database, the system comprising:
a tokenization module configured to process at least a part of a suggestion candidate to generate a plurality of tokens;
a key formation module configured to form at least one multi-layered key based on one or more of the plurality of tokens; and
a key storage unit configured to store the at least one multi-layered key associated with the suggestion candidate.

23. The system of claim 22, wherein the at least one multi-layered key includes two layers with a first layer comprising a first token and a part of a second token, and a second layer comprising the second token.

24. The system of claim 22, wherein each of the plurality of tokens corresponds to an n-gram extracted from the at least a part of the suggestion candidate, and the key formation module is configured to form the at least one multi-layered key based on a plurality of consecutive n-grams.

25. The system of claim 22 further comprising at least one unit selected from the group consisting of
a relevance calculation unit configured to calculate relevance between the at least one multi-layered key and the suggestion candidate, and
a rareness calculation unit configured to calculate rareness of the at least one multi-layered key.
